(19) United States
(12) Patent Application Publication
(10) Pub. No.: US 2005/0061138 A1
(43) Pub. Date: Mar. 24, 2005

(54) Anchoring apparatus for musical instrument stands

(76) Inventor: Lance Justis, Norwalk, CT (US)

Correspondence Address: STURM & FIX LLP, 206 SIXTH AVENUE, SUITE 1213, DES MOINES, IA, 50309-4076, US

(21) Appl. No.: 10/669,245

(22) Filed: Sep. 24, 2003

(51) Int. Cl. G10D 13/02

(52) U.S. Cl. 84/421

(57) ABSTRACT

An anchor apparatus (10) for temporarily immobilizing the foot portions (102) of the support legs (101) of a musical instrument stand (100) relative to a carpeted surface wherein, the apparatus (10) includes a generally thin, flat base member (20) having a bottom surface (22) provided with a hooked portion (23) and a top surface (21) provided with a raised wall member (30) defining a vertical opening (31) that is dimensioned to receive one of the foot portions (102) of the musical instrument support stand (100).

### BACKGROUND OF THE INVENTION

### CROSS REFERENCE TO RELATED APPLICATIONS

Not applicable.

1. Field of the Invention

The present invention relates to the field of musical instrument anchoring systems in general and in particular to an anchoring system that is specifically designed to anchor the legs of cymbal, drum and snare stands.

2. Description of Related Art

As can be seen by reference to the following U.S. Pat. Nos. 5,743,506; 5,994,634; 5,823,492; 5,868,372; and, 6,119,998, the prior art is replete with myriad and diverse arrangements for protecting carpets from damage caused by heavy objects resting on the carpet surface.

While all of the aforementioned prior art constructions are more than adequate for the basic purpose and function for which they have been specifically designed, they are uniformly deficient with respect to their failure to realize that this broad concept has other practical applications specifically in the music industry wherein, it is necessary to stabilize or temporarily anchor a percussion musical instrument on a carpeted surface.

As most musicians are all too well aware, when playing different venues, the rubber capped feet of percussive instrument stands do not provide adequate purchase or stability when resting on a carpeted surface,

As a consequence of the foregoing situation, there has existed a longstanding need among musicians for a new and improved instrument anchoring apparatus that securely positions a percussive instrument stand on a carpeted surface in a quick and efficient manner; and, the provision of such an apparatus in the stated objective of the present invention.

### BRIEF SUMMARY OF THE INVENTION

Briefly stated, the anchor apparatus that forms the basis of the present invention comprises in general a base unit and a capture unit preferably formed integrally with one another wherein, a portion of the base unit is adapted to captively engage a carpeted surface and the capture unit is adapted to slidably receive and laterally immobilize one of the feet of a musical instrument support stand.

As will be explained in greater detail further on in the specification, the base unit comprises in general a thin, flat base member having a bottom surface provided with the hooked portion of a hook and loop fastener.

In addition, the capture unit comprises a raised wall member that extends upwardly from the top surface of the base member, and further defines a vertical opening that is dimensioned to laterally receive and immobilize one of the foot portions of a musical instrument stand.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view of the anchoring apparatus that forms the basis of the present invention in use;

FIG. 2 is a top plan view of one of the preferred embodiments of the invention;

FIG. 3 is a bottom perspective view of the base unit;

FIG. 4 is a perspective view of another preferred embodiment of the invention;

FIG. 5 is a side elevation view of the anchoring apparatus; and,

FIG. 6 is a top plan view of the second version of the preferred embodiment.

### DETAILED DESCRIPTION OF THE INVENTION

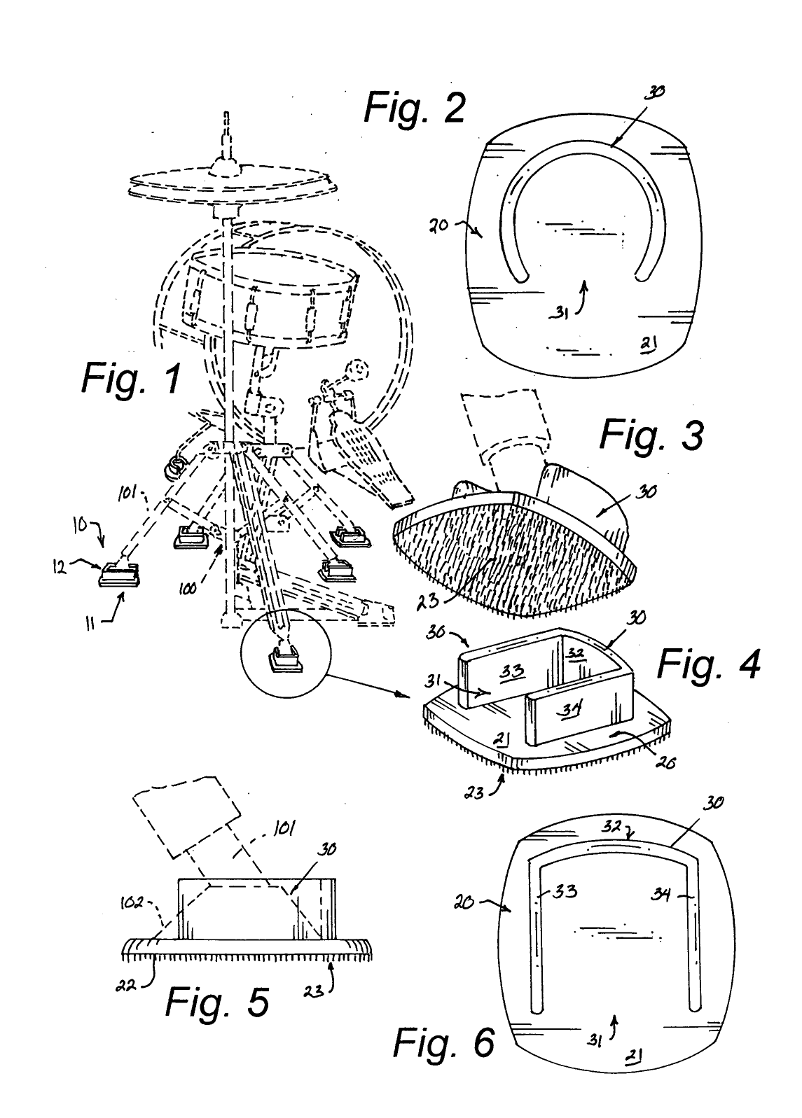

As can be seen by reference to the drawings, and in particular to FIG. 1, the anchoring apparatus for musical instrument stands that forms the basis of the present invention is designated generally by the reference number 10. The anchoring apparatus 10 comprises in general a base unit 11, and a capture unit 12. These units will now be described in seriatim fashion.

As can best be seen by reference to FIGS. 2 through 4, the base unit 11 comprises a generally thin, flat base member 20 having a top surface 21 and a bottom surface 22 wherein, the bottom surface 22 is further provided with the hooked portion 23 of a conventional hook and loop fastener.

Turning now to FIGS. 2,4, and 6, it can be seen that the capture unit 12 comprises a raised wall member 30 formed integrally with, and extending upwardly from, the top surface 21 of the base member 20 wherein, the raised wall member 30 is provided with an opening 31 that is dimensioned to laterally to receive the foot portion 102 of one of the support legs 101 of a musical instrument support stand 100.

Furthermore, as can best be appreciated by reference to FIGS. 2 and 6, in the first version of the preferred embodiment, the raised wall member 30 has an arcuate, generally C-shaped configuration wherein, in the second version of the preferred embodiment, the front portion 32 of the raised wall member 30 is slightly curved and further connects a pair of opposed generally straight side wall portions 33 34 to one another.

It should be noted at this juncture that the generally straight side wall portions 33 34 of the second version of the preferred embodiment are provided to restrict any lateral displacement of the foot portion 102 of the musical instrument support stand 100 relative to the raised wall member 30.

In use, a plurality of anchor apparatuses 10 would be operatively engaged with the foot portions 102 of a like plurality of the support legs 101 of a musical instrument support stand 100 wherein, the hooked element 23 would engage the surface of a rug (not shown) to stabilize the instrument support stand 100 as previously described herein. It should further be noted at this juncture that in both of the preferred versions, the base member 20 and the raised wall member are fabricated from hard rubber.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

1. An anchor apparatus for temporarily immobilizing the feet of the support legs of a musical instrument stand wherein, the apparatus comprises
a base unit comprising a generally thin flat base member having a top surface and a bottom surface wherein, the bottom surface is further provided with a hooked portion; and,
a capture unit including a raised wall member projecting upwardly from the top surface of the base member wherein, the raised wall member is provided with a vertical opening dimensioned to receive the foot portion of a musical instrument stand.

2. The apparatus as in claim 1; wherein, the raised wall member is formed integrally with the base member.

3. The apparatus as in claim 1; wherein, the raised wall member has a generally C-shaped configuration.

4. The apparatus as in claim 1; wherein, the raised wall member has a front portion flanked by two generally straight opposed sidewall portions.

5. The apparatus as in claim 4; wherein, said front portion is curved.
